(19) United States
(12) Patent Application Publication
(10) Pub. No.: US 2008/0159488 A1
(43) Pub. Date: Jul. 3, 2008

(54) Voice based caller identification and screening

(76) Inventor: Chander Raja, Washington, DC (US)

Correspondence Address: TEXAS INSTRUMENTS INCORPORATED, P O BOX 655474, M/S 3999, DALLAS, TX, 75265, US

(21) Appl. No.: 11/645,857

(22) Filed: Dec. 27, 2006

(51) Int. Cl. H04M 1/64

(52) U.S. Cl. 379/88.02

(57) ABSTRACT

Verification of Caller identification, used independently of caller ID or as an adjunct to caller ID for caller verification by matching caller voice samples to voice samples previously stored. Verification algorithms can be implemented as a stand alone device connected to the telephone line or the interne, in software which can be a resident on a PSTN phone, mobile phone or an IP phone or resident on a computer. Voice samples of the current caller are recorded and compared a database of previously recorded voice samples. When a call is received for the first time, the caller records the caller's name which is stored into a database and correlated with the received caller ID information of the present caller, if such information was received. If no caller ID information is received, the voice sample is stored in the database with an indication of a lack of caller ID information. The collection and storage of voice samples allows the use of such samples for voice authentication if the caller calls again. When a caller calls again, the caller records the caller's name as the current caller's voice sample which is compared to the stored database. The enhanced accuracy will aid in acceptance and rejection decisions as well as decisions regarding the handling of incoming telephone calls and will aid in the retrieval of additional information regarding the caller if available.

### CROSS REFERENCE TO RELATED APPLICATIONS

None.

### FIELD OF THE INVENTION

The invention relates to the identification of a calling party by a called party during a telephone call. More specifically, the present invention utilizes biometric information to confirm and/or refute the accuracy of caller identification information received over a telecommunication system.

### BACKGROUND OF THE INVENTION

Caller identification is used to provide a called party with the telephone number of a calling party. The telephone number is provided to the called party in the form of a caller ID signal which is transmitted over the standard telephone line, mobile network or the internet. Caller identification is intended as a means for the called party to ascertain the identity of the calling party before answering the telephone call. In its simplest form, the called party can look at the caller ID information and use the knowledge to screen calls prior to answering. This can be implemented using a standard caller ID display device which displays the number of the calling party and can also displays the name of the calling party, if available. Unfortunately, if this information is incorrect, the called party will not know the correct identity of the caller.

The called party can also use the information provided by a caller ID to more efficiently and more effectively answer a telephone call. There are a number of devices which can implement the automatic retrieval of additional information upon receipt of caller identification. Typically this additional information is stored in a database maintained by the called party. The retrieval of this additional information is most often implemented by connection of the telephone line to a computer system. The computer system receives and process the caller ID information and compares the caller ID information to a database to determine if additional information on the caller is available. The user of such a database system will then have additional information which has been correlated to the caller ID. However, if the caller ID information is incorrect, then the additional data base information will not correlate to the actual caller.

Additionally, the calling party can choose to block the transmission of the calling party's caller ID thereby preventing the called party from receiving the caller ID of the calling party. It is often the case that proper identification of a caller is most desired when the caller chooses to block the caller's identification. In addition, the caller can in some cases implement caller ID spoofing. With caller ID spoofing, the caller can arrange for a false caller ID to be sent to the called party. This technique is often used by callers who know that their calls will be rejected if the true identity of the caller is known.

With conventional caller ID, the called party must rely upon the caller ID signal which is sent through the telephone line, mobile network or internet for caller identification. The called party cannot verify that the received caller ID signal is accurate.

### SUMMARY OF THE INVENTION

The present invention teaches a technique for an alternative method of identification of a caller, which can be used independently of caller ID or as an adjunct to caller ID for caller verification. The present invention teaches a method for caller identification and screening by matching caller voice samples to voice samples previously stored in persistent memory. The memory may be part of a computer connected to the telephone line to receive caller ID information or may be a separate storage accessed by a computer or directly by the telephone. This method can be used to complement and assist traditional caller ID as an effective call screening tool. The use of voice identification addresses the issues of incorrect, spoofed or false caller ID information.

The present invention can be implemented as a stand alone device connected to the telephone line or the internet. Alternatively the present invention can be implemented in software which can be a resident on a PSTN phone, mobile phone or an IP phone or resident on a computer connected to the telephone line or the internet. The device records voice samples of the caller and compares the recorded voice samples to a database of previously recorded voice samples. The database could originally sync up with a user's existing address/phone book such as that from Outlook/Lotus Notes. Voice samples will be added to the entries during normal course of operation of the system.

When a call is received, the device taught in the present invention answers the call and presents a voice prompts to the caller asking the caller to announce the caller's name. Once the caller has provided the caller's name as the caller's voice sample, it is recorded and stored into a database and correlated with the received caller ID information of the present caller, if such information was received. If no caller ID information is received, the voice sample is stored in the database with an indication of a lack of caller ID information. The collection and storage of voice samples allows the use of such samples for voice authentication if the caller calls again. Through implementation of the voice authentication in combination with the caller ID, the called party will obtain information regarding the caller with greater accuracy. The enhanced accuracy will aid in acceptance and rejection decisions as well as decisions regarding the handling of incoming telephone calls and will aid in the retrieval of additional information regarding the caller if available.

The voice recognition device can also be configured for automated handling of incoming calls. For example, the called party can select automatic screening or rejection of calls from particular parties. The system can also be configured for automated rerouting of calls, for example, calls where voice authentication is not confirmed may be routed to voice mail. The device can also be configured to only allow calls from certain people or groups of people. All other calls can be rejected based on a comparison of the current voice sample to the existing database of voice samples collected from previous calls.

In some instances, the caller ID may reside in the database but the voice fails authentication. The system can be configured to prompt for additional information if the caller ID is known and the initial voice sample fails authentication. This will help to reduce rejection of calls which should be accepted. The system can also prompt for additional voice sampling if the caller ID may be used by more than one person, such as an office which may share a common outgoing line amongst several employees. The system can also be configured to prompt for additional voice sampling to aid in better future recognition. The system is flexible in allowing the addition of new recognized callers and in adopting to better recognition through additional voice sampling.

In the event that no voice sample data has yet been stored for a particular caller, the user of the system can always rely upon the caller ID information provided for screening. Although the user must rely upon the provided caller ID without the ability for voice verification, the system continues to collect voice samples to provide voice verification the next time the caller calls.

There are many techniques taught by the present invention for increasing both voice recognition accuracy and voice recognition speed. For example, in one embodiment, voice samples may be indexed according to different various characteristics of the speech that is recorded in the sample. For example, the frequency range of speech may be used as indexing factor two allow for faster voice verification matches during a real time voice verification. By indexing previously stored voice samples, a current voice sample can be first compared to its most likely subset of saved voice samples.

The voice recognition as a complement for caller ID verification allows for greater accuracy in the identification of a caller. Although it is not impossible to spoof or imitate a different caller's voice, it is much more difficult to do so than to spoof a false text based caller ID.

In a further embodiment of the present invention, the system can be configured to deliver specific customized messages to specific callers if they are voice identified. A user of the system, can record special messages for a particular caller such as a friend, a family member or a coworker. The special messages will then be delivered only to the intended caller when the intended caller calls the user and the identification of the intended caller is authenticated using the voice simple authentication technique of the present intention.

The present invention, in another embodiment, includes a screening algorithm which supports a selective do not disturb mode so that the system does not announce calls according to a predetermined set of conditions. For example, the system may only announce voice authenticated calls from certain callers. The system may be programmed to only announce calls during certain times of the day unless the calls are from certain specific persons who may be assigned calling privileges during do not disturb time periods, such as nighttime. The system allows for sophisticated call screening without the need for the called party to personally, visually observe caller identification information.

The system further includes logic to handle callers who could call from different numbers. For example, if the user authenticates a caller's voice sample for their main phone number and the caller then calls from another phone number, the voice sample can be authenticated with the previously stored sample but will not correlate to the new caller ID. The system will announce the identity of the caller based on voice sample matching alone and indicate that the current caller ID does not match the stored ID. The user then has the option to associate the new number with the calling party's record in the database since the new number may be the caller's mobile phone or the user can chose not to do so if the caller is calling from someone else's phone.

In other situations, there may be more than one authentic caller from a single ID. Multiple callers can be valid and separately identified with a common ID in such situations. With certain internal phone systems, all outgoing lines from an office will show up with one number in the Caller ID instead of the actual number of the individual caller. In this case the user will have to manually associate this number and caller voice sample with an already existing entry for the caller or add and additional caller associated with an existing ID in the database. There will be an option to add this number as an “outbound number” for the caller's entry as opposed to the caller's real phone number. So each caller may have multiple valid phone numbers associated with the caller, such as a home number, a mobile number, one or more outbound or office numbers, etc.

Multiple authorized callers using the same number can also occur with individual family members calling on a home phone. When a voice sample does not match the voice sample associated with the number received as Caller ID, the system still plays the voice sample to the user but will also report “Unauthenticated” to the user. This may be the case when several family members share the same home number. The user can then associate the new caller's voice sample with the existing ID number. Next time there is a call from this number, the system can first try to match the voice sample with all the voice samples associated with the received number before widening the search to the entire voice sample database.

### BRIEF DESCRIPTION OF THE DRAWINGS

Exemplary embodiments of the present invention are discussed with reference to the following drawings:

FIG. 1 is a schematic block diagram illustrating the components and illustrating the logical flow of exemplary algorithms of the present invention.

### DETAILED DESCRIPTION OF THE INVENTION

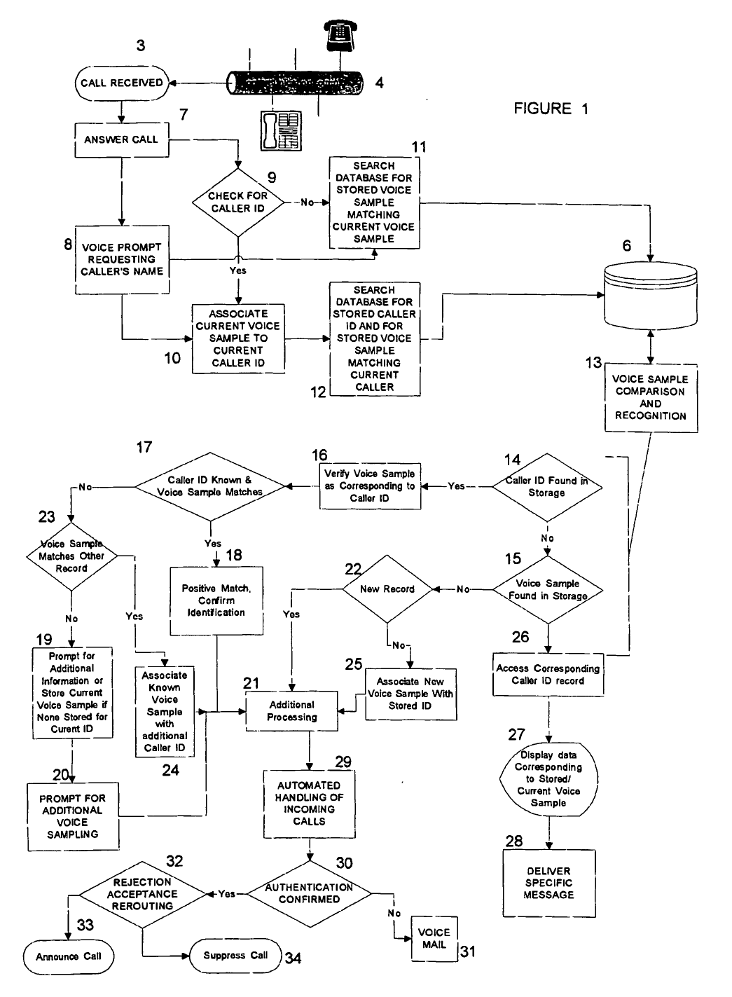

As illustrated in FIG. 1, A communication device 3, is connected to communication circuit 4. Communication device 3 can be implemented as a stand alone device connected to a standard telephone line or an VOIP device connected to the internet. Alternatively the present invention can be implemented in software which can be a resident on a PSTN phone, mobile phone or an IP phone or resident on a computer, connected to the communication circuit 4. Caller ID reception and capabilities are included in the communication device 3. In addition to the standard detection capabilities, the additional features of the present invention are also included. An internal or external data base 6 for storage of voice samples, caller ID information and associated caller information can be implemented as stand alone, networked or integrated storage.

When a call is received by communications device 3, the device answers the telephone call 7 and presents a voice prompts to the caller 8. The voice prompts requests the caller to announce the caller's name. When the caller speaks his or her name, the device may announce the name over a speaker and the called party may decide whether to answer the call or not based upon the announced voice. The system also checks for caller ID information 9 and displays the caller ID information in a standard manner, if desired. The system associates the current speaker's voice samples with the caller ID if a caller ID was received by the system 10. The called party, having heard the voice and seen the caller ID information can then make determinations regarding the properties to ascribe to the stored information.

If no caller ID information is received, the system searches the database for stored voice samples which match the current voice sample 11. The voice sample may be stored in the database 6 with an indication of a lack of caller ID information. If a caller ID has been detected, the search 12 can be initially more narrowly focused by comparison to stored voice samples associated with the identified caller ID, if the identified caller ID is stored in the system. If the identified caller ID is new, then a new record may be created.

The called party has access to the database 6 and can establish the logical rules for call processing to accommodate the individual user within the teachings of the present invention as detailed herein. The following description details the several aspects of the various implementations of the various features available in the various embodiments of the present invention as taught herein. The called party can therefore configure the parameters of the database to store calls, create new records, associate new caller Id's and/or new voice samples with old or new records, to accommodate the users preferences for the system.

The current voice sample of the caller is presented to the database 6 with or without caller ID information. A voice sample comparison and recognition is then performed 13, according to the rules established by the called party user. The caller ID and the current voice samples are compared to a database of previously recorded voice samples 6. The system checks for a caller ID match 14 and also for a voice sample match 15. If there is a caller ID record match, the systems compares the current voice sample to any corresponding stored voice sample 16. If the ID and sample match 17, then the system may indicate a positive match and confirmation of a known ID and caller voice sample 18. If the ID and sample do not match 17 then the system will compare the voice sample to determine if it matches another caller ID 23. A decision is then may be made to associate the known voice sample with the current caller ID 24 or to reject the call as invalid. If the voice sample is not recognized, the system may prompt for additional information 19. If the Caller ID is known but there is no corresponding stored voice sample, the user may select to have the current voice sample stored 19 as corresponding to the stored caller ID. The voice sample may fail authentication because it is not the correct caller or because the correct caller's voice is not recognized. To reduce rejection of calls which should be accepted, the system may prompt for additional voice sampling 20 or other information 19. The system may prompt for additional voice sampling to aid in better future recognition or to add additional valid callers to the stored ID record. This may require additional processing 21.

In the event that neither the Caller ID nor the Voice Sample are recognized as previously stored 22, a new record may be created, requiring additional processing 21. Alternatively, the new voice sample may be associated with a stored caller ID 25.

If there is a match between the current caller ID and the current voice sample, the corresponding stored record is accessed 26 and any desired data is displayed 27.

In a further embodiment of the present invention, the system can be configured to deliver specific customized messages 28 to specific callers if they are voice identified as described above.

In another embodiment, the present invention may include automated call handling 29. The voice recognition device can also be configured for automated handling of incoming calls 29. The called party with access to the database 6 can configure the parameters of the database to store, allow or reject calls from one or more selected groups of callers. Once these parameters have been established by the user of the system, the device can automatically implement the desired parameters based on a real time comparison of a voice sample of the caller to the voice samples which have already been stored in the database and authenticated by the user. During automated handling 29, the system may determine authenticity of the call 30. The system can be configured for automated rerouting of calls, for example, calls where voice authentication is not confirmed may be routed to voice mail 31. The called party can select automatic screening or rejection of calls from particular parties or at particular times of day 32. The device can also be configured to only allow calls from certain people or groups of people 32. Same calls may be announced or allowed 33 while other calls can be rejected 34.

There are many exemplary embodiments for screening algorithms which may support a selective do not disturb mode so that the system does not announce calls according to a predetermined set of conditions. For example, the system may only announce voice authenticated calls from certain callers. The system may be programmed to only announce calls during certain times of the day unless the calls are from certain specific persons who may be assigned calling privileges during do not disturb time periods, such as nighttime. The system allows for sophisticated call screening without the need for the called party to personally, visually observe caller identification information.

The system further includes logic to handle callers who could call from different numbers. For example, if the user authenticates a caller's voice sample for their main phone number and the caller then calls from another phone number, the voice sample can be authenticated with the previously stored sample but will not correlate to the new caller ID. The system will announce the identity of the caller based on voice sample matching alone and indicate that the current caller ID does not match the stored ID. The user then has the option to associate the new number with the calling party's record in the database since the new number may be the caller's mobile phone or the user can chose not to do so if the caller is calling from someone else's phone.

In other situations, there may be more than one authentic caller from a single ID. Multiple callers can be valid and separately identified with a common ID in such situations. With certain internal phone systems, all outgoing lines from an office will show up with one number in the Caller ID instead of the actual number of the individual caller. In this case the user will have to manually associate this number and caller voice sample with an already existing entry for the caller or add and additional caller associated with an existing ID in the database. There will be an option to add this number as an “outbound number” for the caller's entry as opposed to the caller's real phone number. So each caller may have multiple valid phone numbers associated with the caller, such as a home number, a mobile number, one or more outbound or office numbers, etc.

Multiple authorized callers using the same number can also occur with individual family members calling on a home phone. When a voice sample does not match the voice sample associated with the number received as Caller ID, the system still plays the voice sample to the user but will also report “Unauthenticated” to the user. This may be the case when several family members share the same home number. The user can then associate the new caller's voice sample with the existing ID number. Next time there is a call from this number, the system can first try to match the voice sample with all the voice samples associated with the received number before widening the search to the entire voice sample database.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A method of verification of Caller identification, comprising:
detecting the presence or absence of a current caller ID signal on a communication line during a incoming call from an originating party;
decoding said current caller ID signal if present on said line;
answering said incoming call and providing a prompt for the originating party to provide voice identification as a current voice sample; and
comparing said current caller ID and/or said current voice sample to a database of previously saved caller ID's and voice samples.

2. The method of claim 1, further comprising:
providing a database of previously saved voice samples correlated to previously saved corresponding caller ID's.

3. The method of claim 1, further comprising:
determining if either said current caller ID or said current voice sample match any of said saved caller ID's or said saved voice samples.

4. The method of claim 3, further comprising:
associating said current voice sample with said current caller ID; and
creating a new record in said database of said current caller ID and said current voice samples if said determination does not find any match for said current caller ID or said current voice sample.

5. The method of claim 1, further comprising:
comparing said current caller ID with said stored caller ID's in said database;
finding a stored caller ID within said database, matching said current caller ID;
retrieving the database record corresponding to said found stored caller ID and accessing a corresponding stored voice sample associated with said retrieved database record;
comparing said current voice sample to said corresponding stored voice sample; and
displaying data associated with said record when said current caller ID and said current voice sample, match said found stored caller ID and said corresponding stored voice sample.

6. The method of claim 5, further comprising:
indicating validation of caller ID information when said current caller ID and said current voice sample, match said found stored caller ID and said corresponding stored voice sample.

7. The method of claim 1, further comprising:
comparing said current caller ID with said stored caller ID's in said database;
finding a stored caller ID within said database, matching said current caller ID;
retrieving the database record corresponding to said found stored caller ID and accessing a corresponding stored voice sample associated with said retrieved database record;
comparing said current voice sample to said corresponding stored voice sample; and
adding said current voice sample to said retrieved database record as an additional corresponding voice sample, when said current caller ID matches said found stored caller ID and said current voice sample does not match said corresponding stored voice sample.

8. The method of claim 1, further comprising:
comparing said current voice sample with said stored voice samples in said database;
finding a stored voice sample within said database, matching said current voice sample;
retrieving the database record corresponding to said found stored voice sample and accessing a corresponding stored caller ID associated with said retrieved database record;
comparing said current caller ID to said corresponding stored caller ID; and
associating said current caller ID with said found stored voice sample as an additional caller ID corresponding to said found stored voice sample, when said current voice sample matches said found stored voice sample and said current caller ID does not match said corresponding stored caller ID.

9. The method of claim 1, further comprising:
displaying the caller ID information if present; and
playing said current voice sample to the called party.

10. The method of claim 1, further comprising:
providing a configurable, rule-based processor for identification and handling of voice samples and associated current calls.

11. The method of claim 1, further comprising:
determining that a current caller ID is invalid if the current voice sample does not match the saved voice sample associated with a saved caller ID corresponding to the current caller ID.

12. The method of claim 1, further comprising:
storing the current voice sample as corresponding to a stored caller ID when the current caller ID is found as a stored in said database without a corresponding stored voice sample.

13. The method of claim 1, further comprising:
providing a prompt for additional voice sampling; and
recording said additional voice sampling; and
analyzing said additional voice sampling for correspondence with stored voice samples.

14. The method of claim 5, further comprising:
tagging particular database records for receipt of customized messages; and
delivering specific customized messages to said calling party when said current caller ID and said current voice sample, match said found stored caller ID and said corresponding stored voice sample of one of said tagged database records.

15. The method of claim 1, further comprising;
routing said current call to voice mail when no match if found between said current caller ID or said current voice sample and said stored caller ID's and stored voice samples.

16. The method of claim 1, further comprising:
assigning database records to predefined groups;
establishing automatic screening parameters for current calls which are identified as corresponding to database records assigned to a predetermine one of said predefined groups.

17. The method of claim 16, further comprising;
defining screening parameters based upon the time of day of receipt of the current call.

18. A method of verification of Caller identification, comprising:
detecting the presence or absence of a current caller ID signal on a communication line during a incoming call from an originating party;
decoding said current caller ID signal if present on said line;
answering said incoming call and providing a prompt for the originating party to provide voice identification as a current voice sample;
providing a database of previously saved voice samples correlated to previously saved corresponding caller ID's;
comparing said current caller ID and/or said current voice sample to a database of previously saved caller ID's and voice samples;
determining if either said current caller ID or said current voice sample match any of said saved caller ID's or said saved voice samples, including:
comparing said current caller ID with said stored caller ID's in said database;
comparing said current voice sample with said stored voice samples in said database;
finding a stored caller ID within said database, matching said current caller ID;
finding a stored voice sample within said database, matching said current voice sample;
retrieving the database record corresponding to said found stored caller ID and accessing a corresponding stored voice sample associated with said retrieved database record;
retrieving the database record corresponding to said found stored voice sample and accessing a corresponding stored caller ID associated with said retrieved database record;
comparing said current voice sample to said corresponding stored voice sample; and
comparing said current caller ID to said corresponding stored caller ID;
displaying data associated with said record and indicating validation of caller ID information when said current caller ID and said current voice sample, match said found stored caller ID and said corresponding stored voice sample;
adding said current voice sample to said retrieved database record as an additional corresponding voice sample, when said current caller ID matches said found stored caller ID and said current voice sample does not match said corresponding stored voice sample;
associating said current caller ID with said found stored voice sample as an additional caller ID corresponding to said found stored voice sample, when said current voice sample matches said found stored voice sample and said current caller ID does not match said corresponding stored caller ID;
associating said current voice sample with said current caller ID and creating a new record in said database of said current caller ID and said current voice samples if said determination does not find any match for said current caller ID or said current voice sample; and
storing the current voice sample as corresponding to a stored caller ID when the current caller ID is found as a stored record in said database without a corresponding stored voice sample.
